(19) United States
(12) Patent Application Publication
(10) Pub. No.: US 2015/0041732 A1
(43) Pub. Date: Feb. 12, 2015

(54) CERAMIC COMPOSITION FOR THERMISTOR TEMPERATURE SENSOR AND THERMISTOR DEVICE MANUFACTURED USING THE COMPOSITION

(71) Applicant: Taesung Electro-Circuit Systems, Cheonan (KR)

(72) Inventors: Choon Sik Kim, Cheonan (KR); Jae Moon Jung, Cheonan (KR)

(21) Appl. No.: 14/523,312

(22) Filed: Oct. 24, 2014

Related U.S. Application Data
(63) Continuation of application No. PCT/KR2013/004779, filed on May 30, 2013.

(30) Foreign Application Priority Data
Jun. 28, 2012 (KR) 10-2012-0069731

(51) Int. Cl. H01C 7/00; G01K 7/22

(52) U.S. Cl. CPC H01C 7/008; G01K 7/22
USPC 252/519.13; 252/519.1; 252/519.15

(57) ABSTRACT

This invention relates to a ceramic composition, which is suitable for use in DOC and DPF for removing nitrogen oxide, carbon monoxide and unburned particles from exhaust gas systems of vehicles or for use in a thermistor temperature sensor for an industrial high-temperature environment similar thereto, and to a thermistor device manufactured using the composition. The ceramic composition is prepared by adding a perovskite phase having a perovskite crystalline structure represented by ABO3 with Sn of Group 4B or Sb or Bi of Group 5B, wherein A includes at least one element selected from among Groups 2A and 3A elements except for LA, and B includes at least one element selected from among transition metals of Groups 4A, 5A, 6A, 7A, 8A, 2B and 3B.

### CROSS-REFERENCE TO RELATED APPLICATIONS

This is a continuation of International Application No. PCT/KR2013/004779 filed May 30, 2013, which claims priority to Korean Application No. 10-2012-0069731 filed on Jun. 28, 2012. The applications are incorporated herein by reference.

### TECHNICAL FIELD

The present invention relates to a ceramic composition, which is suitable for use in a diesel oxidation catalyst (DOC) and a diesel particulate filter (DPF) for removing nitrogen oxide, carbon monoxide and unburned particles from exhaust gas systems of vehicles or for use in a thermistor temperature sensor for an industrial high-temperature environment similar thereto, and to a thermistor device manufactured using the composition.

### BACKGROUND ART

The present invention relates to a ceramic composition, which is suitable for use in DOC and DPF for removing nitrogen oxide, carbon monoxide and unburned particles from exhaust gas systems of vehicles or for use in a thermistor temperature sensor for an industrial high-temperature environment similar thereto, and to a thermistor device manufactured using the composition.

Five to ten kinds of temperature sensors are applied to vehicles. Almost all kinds of sensors used in the temperature sensors include a ceramic thermistor using an oxide semiconductor. The reason why the ceramic thermistor is used is that it is inexpensive and satisfies reliability required of vehicles. Although the temperature range of the ceramic thermistor may vary depending on the application position thereof, when it is applied to an engine room, the temperature range may be set to −40˜150° C., and in the case of HVAC, the temperature range of −40˜80° C. is applied.

In addition, a vehicle sensor, which is newly receiving attention, requires an increase in fuel efficiency based on international environmental regulations and also the detection of temperature, pressure, oxygen or nitrogen content of exhaust systems by the regulation of harmful components of exhaust gases.

The sensing range of the temperature sensor for use in an exhaust gas system is typically set to 300˜800° C. In the case of DPF, the temperature range of −40˜900° C. should be set so as to satisfy international OBD II standards.

Furthermore, as a direct spray manner is applied to a gasoline engine, a gasoline engine needs a filter for filtering exhaust gas discharged upon initial startup in cold weather. In the case of the gasoline engine, the temperature up to 1000° C. should be measured, which is regarded as difficult. Hence, there is a need for a composition having a low B constant relative to a high resistance value in order to satisfy such a temperature range.

In this regard, conventional techniques include U.S. Pat. No. 6,306,315 (Patent Document 1) and U.S. Pat. No. 7,656,269 (Patent Document 2). In the case of the oxide disclosed in Patent Document 1, the resistance at −40° C. is 110˜100 Ω, and the B constant is 2200˜2480K Furthermore, the resistance at about 900° C. is maintained to the level of 50Ω or less, and thus high-temperature resolution becomes poor, and output voltage is lowered to about 0.1 V, undesirably decreasing consumer utilization.

Patent Document 2 shows similar trends to Patent Document 1.

Moreover, in the case where the oxide is allowed to stand for a long period of time at high temperature, a change over time at high temperature is regarded as important. There is thus a continuous need for the development of an oxide having improved properties.

### SUMMARY

Accordingly, an object of the present invention is to provide a ceramic composition for a thermistor temperature sensor and a thermistor device manufactured using the composition, wherein a conventional oxide may be added with another kind of oxide, thus exhibiting appropriate resistance and a low B constant.

Another object of the present invention is to provide a ceramic composition for a thermistor temperature sensor and a thermistor device manufactured using the composition, wherein the measurement of a temperature in the wide range of −40˜1000° C. is possible.

In order to accomplish the above objects, the present invention provides a ceramic composition for a thermistor temperature sensor, prepared by adding a perovskite phase having a perovskite crystalline structure represented by ABO3 with Sn of Group 4B or Sb or Bi of Group 5B, wherein A comprises at least one element selected from among Groups 2A and 3A elements except for LA, and B comprises at least one element selected from among transition metals of Groups 4A, 5A, 6A, 7A, 8A, 2B and 3B.

According to a preferred embodiment of the present invention, the mixing ratio of A and B in the perovskite crystalline structure represented by ABO3 is 1:1, and when the element of A is set to M1; the element of B is set to M2; and Sn of Group 4B or Sb or Bi of Group 5B is set to M3, M1, M2 and M3 satisfy one or more selected from among the following relations:

0≦M1≦1

0≦M2+M3≦1

0≦M3≦0.6.

According to a more preferred embodiment of the present invention, M1 may comprise one or more selected from the group consisting of Y₂O₃, CaCO₃, SrO₂ and MgO.

According to a more preferred embodiment of the present invention, M2 may comprise one or more selected from the group consisting of MnO₂, Cr₂O₃ and NiO.

According to a more preferred embodiment of the present invention, M3 may comprise one or more selected from the group consisting of CuO, SnO, Sb₂O₃, Bi₂O₃, Al₂O₃ and Fe₂O₃.

According to a much more preferred embodiment of the present invention, the ceramic composition may have a temperature gradient constant of 1800˜2600K in the temperature range of −40˜1000° C.

In addition, the present invention provides a thermistor device, manufactured using the ceramic composition as above.

In addition, the present invention provides a temperature sensor, manufactured using the thermistor device as above.

According to the present invention, a ceramic composition for a thermistor temperature to sensor and a thermistor device manufactured using the composition can exhibit appropriate resistance and a low B constant by adding Sn as a Group 4B element or Sb or Bi as a Group 5B element.

Also, the present invention can very effectively provide a thermistor temperature sensor that is able to measure the temperature in the wide range of −40˜1000° C.

### DETAILED DESCRIPTION

Hereinafter, a detailed description will be given of preferred embodiments of the present invention and properties of individual components, which is intended to specifically describe the invention to the extent that the invention may be easily performed by those skilled in the art, but is not construed to limit the spirit and scope of the present invention.

According to the present invention, a ceramic composition for a thermistor temperature sensor is prepared by adding a perovskite phase having a perovskite crystalline structure represented by ABO3 with Sn or Si as a Group 4B element or Sb or Bi as a Group 5B element, wherein A includes at least one element selected from among Groups 2A and 3A elements except for LA, and B includes at least one element selected from among transition metals of Groups 4A, 5A, 6A, 7A, 8A, 2B and 3B.

Also, the mixing ratio of A and B in the perovskite crystalline structure represented by ABO3 is 1:1, and when the element of A is set to M1; the element of B is set to M2; and Sn as a Group 4B element or Sb or Bi as a Group 5B element is set to M3, M1, M2 and M3 satisfy one or more selected from among the following relations:

0≦M1≦1

0≦M2+M3≦1

0≦M3≦0.6.

Conventionally, an oxide is a sintered material having a perovskite structure of M1M2O3, and is configured such that the oxide having a large atomic radius among elements belonging to M1 and M2 is positioned at M1 and the oxide having a comparatively small atomic radius is positioned at M2, so as to facilitate substitution upon synthesis.

In the present invention, as the composition of M1 and M2 is added with M3, the B constant of a thermistor is lowered and also changes in resistance to external heat are reduced to achieve stabilization of the phase. Furthermore, M3 is added to the composition to adjust the number of holes, control a particle size and space between the particles and hinder migration of electrons at different temperatures, and thereby the resulting composition has a lowered B constant and is decreased in deviation depending on the lot of products.

To this end, in a method of manufacturing an NTC thermistor, when ABO3 is configured to include M1 (Y₂O₃, CaCO₃, SrO₂, MgO) including Groups 2A˜3A, M2 (MnO₂, Cr₂O₃, NiO) including transition metals, and M3 (CuO, SnO, Sb₂O₃, Bi₂O₃, Al₂O₃, Fe₂O₃) including Group 4B or 5B, the composition of A and B at 1:1 is provided, wherein A is composed mainly of M1 and B is composed mainly of M2+M3.

The powder components having no M3 were primarily mixed at the mixing ratios shown in Table 1 using wet mixing, and dried at 120° C. for 8 hr, thus obtaining synthetic powder. Subsequently, the dried powder was calcined at 900˜1100° C. for 2˜4 hr, pulverized so as to obtain an average particle size of 0.2˜0.6 μm, after which 90 wt % of the pulverized product was added with 10 wt % of a polyvinyl acetate (PVA) binder, followed by performing spray drying, thus preparing spherical powder, which was then sieved using a sieve of 500 mesh, yielding final powder.

The final powder thus obtained was placed in a special molding machine to obtain a molded body coupled with platinum wires, which was then sintered at 1400˜1550° C. for 2∞4 hr, thereby manufacturing a thermistor device, the resistance values of which were measured at −40° C., 600° C. and 900° C., and B constants were determined by the equation.

The initial resistance values of the thermistor device were measured at −40° C., 600° C. and 900° C. Thereafter, the product was aged at 900° C. for 100 hr, after which resistance values to thereof were measured at −40° C., 600° C., and 900° C. as in the initial conditions, and changes in resistance after aging relative to the initial values were evaluated.

The B constant was calculated by the following equation, and the resistance deviation was calculated, thus determining a resistance change. The results are given in Table 1 below.

### ti B(R1/R2)=In[R1/R2]/[1/T1−1/T2]

As shown in Table 1, as the component ratio of M1 and M2 was adjusted, compositions having desired B constants and resistance values at −40° C. were selected, and the amount of M3 (Group 1B, 4B, 5B) oxide was changed, so that B constants and resistivity changes were evaluated.

TABLE 1

| | | | | | | | | | | | | B | Resistance |
|---|---|---|---|---|---|---|---|---|---|---|---|---|---|
| Sample | M1 | | M2 | | | M1 | M2 | R-40 | R100 | R600 | R900 | (−40/ | Change |
| No. | Element | | Element | | Total | Element | Element | (kΩ) | (kΩ) | (kΩ) | (kΩ) | 900) | (%) |
| 1 | 45 | 5 | 40 | 10 | 100 | Y, Ca | Mn, Cr | 54.93 | 0.897 | 0.0147 | 0.0077 | 2582 | 15 |
| 2 | 45 | 5 | 30 | 20 | 100 | Y, Ca | Mn, Cr | 30.44 | 0.649 | 0.018 | 0.0062 | 2473 | 13 |
| 3 | 45 | 5 | 20 | 30 | 100 | Y, Ca | Mn, Cr | 12.62 | 0.245 | 0.009 | 0.004 | 2344 | 18 |
| 4 | 45 | 5 | 10 | 40 | 100 | Y, Ca | Mn, Cr | 1780 | 74.12 | 0.898 | 0.295 | 2533 | 20 |
| 5 | 40 | 10 | 40 | 10 | 100 | Y, Ca | Mn, Cr | 1.269 | 0.118 | 0.009 | 0.004 | 1676 | 14 |
| 6 | 40 | 10 | 30 | 20 | 100 | Y, Ca | Mn, Cr | 10.3 | 0.680 | 0.066 | 0.019 | 1832 | 13 |
| 7 | 40 | 10 | 20 | 30 | 100 | Y, Ca | Mn, Cr | 15.23 | 0.367 | 0.016 | 0.006 | 2281 | 21 |
| 8 | 40 | 10 | 10 | 40 | 100 | Y, Ca | Mn, Cr | 126 | 10.01 | 0.049 | 0.01 | 2747 | 18 |
| 9 | 45 | 5 | 40 | 10 | 100 | Y, Ca | Mn, Fe | 1264 | 1.318 | 0.015 | 0.004 | 3685 | 15 |
| 10 | 45 | 5 | 30 | 20 | 100 | Y, Ca | Mn, Fe | 395.2 | 0.649 | 0.018 | 0.007 | 3184 | 13 |
| 11 | 45 | 5 | 20 | 30 | 100 | Y, Ca | Mn, Fe | 22.61 | 0.380 | 0.008 | 0.003 | 2598 | 18 |
| 12 | 45 | 5 | 10 | 40 | 100 | Y, Ca | Mn, Fe | 12963 | 256.14 | 12.64 | 3.695 | 2375 | 20 |
| 13 | 40 | 10 | 40 | 10 | 100 | Y, Ca | Mn, Fe | 9912641 | 1093 | 1.095 | 0.268 | 5071 | 14 |
| 14 | 40 | 10 | 30 | 20 | 100 | Y, Ca | Mn, Fe | 557.1 | 1.642 | 0.032 | 0.007 | 3284 | 13 |
| 15 | 40 | 10 | 20 | 30 | 100 | Y, Ca | Mn, Fe | 31.92 | 0.192 | 0.011 | 0.004 | 2614 | 21 |
| 16 | 40 | 10 | 10 | 40 | 100 | Y, Ca | Mn, Fe | 93162 | 128.1 | 0.169 | 0.061 | 4143 | 18 |
| 17 | 45 | 5 | 40 | 10 | 100 | Y, Ca | Mn, Al | 11229 | 22.35 | 0.681 | 0.056 | 3552 | 15 |
| 18 | 45 | 5 | 30 | 20 | 100 | Y, Ca | Mn, Al | 36125 | 1.009 | 0.029 | 0.008 | 4459 | 4 |
| 19 | 45 | 5 | 20 | 30 | 100 | Y, Ca | Mn, Al | 631561 | 92.610 | 0.164 | 0.061 | 4700 | 8 |
| 20 | 45 | 5 | 10 | 40 | 100 | Y, Ca | Mn, Al | 5612462 | 103.9 | 0.267 | 0.091 | 5219 | 10 |
| 21 | 40 | 10 | 40 | 10 | 100 | Y, Ca | Mn, Al | 613.3 | 2.641 | 0.026 | 0.006 | 3356 | 7 |
| 22 | 40 | 10 | 30 | 20 | 100 | Y, Ca | Mn, Al | 22681 | 64.160 | 0.166 | 0.008 | 4323 | 6 |
| 23 | 40 | 10 | 20 | 30 | 100 | Y, Ca | Mn, Al | 634516 | 326.4 | 4.621 | 0.913 | 3914 | 10 |
| 24 | 40 | 10 | 10 | 40 | 100 | Y, Ca | Mn, Al | 5531672 | 1283 | 4.612 | 0.643 | 4646 | 9 |

As is apparent from Table 1, compositions having B constants and resistance values at −40° C. approximate to desired values and low resistance changes upon manufacturing thermistor devices without synthesis of additives using the same ceramic preparation method as above were adopted in order to select base compositions.

TABLE 2

| Sample | M1 | M2 | M3 | | M1 | M2 | M3 | R100 | R600 | B(100/ | Resistance |
|---|---|---|---|---|---|---|---|---|---|---|---|
| No. | Element | Element | Element | Total | Element | Element | Element | (kΩ) | (kΩ) | 600) | Change (%) |
| 2-1 | 50 | 50 | 0 | 100 | Y, Ca | Mn, Cr | — | 0.649 | 0.018 | 2336 | 13 |
| 2-2 | 50 | 49 | 1 | 100 | Y, Ca | Mn, Cr | Cu | 0.612 | 0.017 | 2335 | 19 |
| 2-3 | 50 | 47 | 3 | 100 | Y, Ca | Mn, Cr | Cu | 0.513 | 0.016 | 2260 | 23 |
| 2-4 | 50 | 45 | 5 | 100 | Y, Ca | Mn, Cr | Cu | 0.235 | 0.01 | 2057 | 25 |
| 2-5 | 50 | 40 | 10 | 100 | Y, Ca | Mn, Cr | Cu | 0.082 | 0.005 | 1823 | 31 |
| 2-6 | 50 | 20 | 30 | 100 | Y, Ca | Mn, Cr | Cu | 0.136 | 0.006 | 2034 | 48 |
| 2-7 | 50 | 0 | 50 | 100 | Y, Ca | Mn, Cr | Cu | 0.053 | 0.004 | 1684 | 35 |
| 2-8 | 50 | 49 | 1 | 100 | Y, Ca | Mn, Cr | Sn | 0.623 | 0.018 | 2309 | 7 |
| 2-9 | 50 | 47 | 3 | 100 | Y, Ca | Mn, Cr | Sn | 0.511 | 0.017 | 2218 | 3 |
| 2-10 | 50 | 45 | 5 | 100 | Y, Ca | Mn, Cr | Sn | 0.366 | 0.013 | 2175 | 5 |
| 2-11 | 50 | 40 | 10 | 100 | Y, Ca | Mn, Cr | Sn | 0.568 | 0.018 | 2249 | 9 |
| 2-12 | 50 | 20 | 30 | 100 | Y, Ca | Mn, Cr | Sn | 0.891 | 0.021 | 2442 | 16 |
| 2-13 | 50 | 0 | 50 | 100 | Y, Ca | Mn, Cr | Sn | 1.634 | 0.041 | 2401 | 22 |
| 2-14 | 50 | 49 | 1 | 100 | Y, Ca | Mn, Cr | Sb | 1.721 | 0.046 | 2360 | 5 |
| 2-15 | 50 | 47 | 3 | 100 | Y, Ca | Mn, Cr | Sb | 0.822 | 0.021 | 2390 | 2 |
| 2-16 | 50 | 45 | 5 | 100 | Y, Ca | Mn, Cr | Sb | 1.082 | 0.029 | 2358 | 4 |
| 2-17 | 50 | 40 | 10 | 100 | Y, Ca | Mn, Cr | Sb | 3.264 | 0.085 | 2377 | 6 |
| 2-18 | 50 | 20 | 30 | 100 | Y, Ca | Mn, Cr | Sb | 5.326 | 0.138 | 2380 | 10 |
| 2-19 | 50 | 0 | 50 | 100 | Y, Ca | Mn, Cr | Sb | 12.620 | 0.334 | 2367 | 15 |
| 2-20 | 50 | 49 | 1 | 100 | Y, Ca | Mn, Cr | Bi | 0.823 | 0.021 | 2390 | 6 |
| 2-21 | 50 | 47 | 3 | 100 | Y, Ca | Mn, Cr | Bi | 0.921 | 0.025 | 2350 | 3 |
| 2-22 | 50 | 45 | 5 | 100 | Y, Ca | Mn, Cr | Bi | 1.356 | 0.036 | 2365 | 3 |
| 2-23 | 50 | 40 | 10 | 100 | Y, Ca | Mn, Cr | Bi | 3.621 | 0.0956 | 2368 | 7 |
| 2-24 | 50 | 20 | 30 | 100 | Y, Ca | Mn, Cr | Bi | 9.162 | 0.246 | 2357 | 9 |
| 2-25 | 50 | 0 | 50 | 100 | Y, Ca | Mn, Cr | Bi | 16.023 | 0.426 | 2364 | 16 |

In the compositions of Table 1, Y and Ca were positioned at the A site. At the B site, Mn and Cr, Fe or Al were positioned at different ratios, provided that the total sum thereof was maintained at 50 wt %, and B constants and resistance changes after aging at respective temperatures were measured.

The composition of Sample No. 2 in Table 1 was added with Cu of Group 1B, Sn of Group 4B, and Bi and Sb of Group 5B at predetermined ratios, and thus the resulting samples were measured in terms of B constants, resistance values and resistance changes.

To increase stability of resistance changes, Cu, Sn, Sb or Bi was added in amounts of 1 wt %, 3 wt %, 5 wt %, 10 wt %, 30 wt % and 50 wt %. The addition of impurities and additives in the ABO3 structure such as perovskite was effective at decreasing the rate of recombination of electrons and holes and increasing thermal stability, and had no great influence on the B constant relative to the resistance value but resulted in reduced changes in the samples.

When adding +3 ions such as Sb or Bi, part of the A site is substituted and thus electrical conduction is performed by electronic interaction and exchange of Y ions. Upon excessive addition, an excess of such an additive is mainly positioned at the intergranular face and thus hinders the migration of electrons at room temperature or a comparatively low temperature of 300° C. or less, and thereby the resistance value is increased but the B constant is maintained almost the same.

Sample No. 2-19 or 2-25 of Table 2 represents such an electrical principle.

TABLE 3

| Sample | M1 | M2 | M3 | | M1 | M2 | M3 | R100 | R600 | B(100/ | Resistance |
|---|---|---|---|---|---|---|---|---|---|---|---|
| No. | Element | Element | Element | Total | Element | Element | Element | (kΩ) | (kΩ) | 600) | Change (%) |
| 6-1 | 50 | 50 | 0 | 100 | Y, Ca | Mn, Cr | — | 0.680 | 0.032 | 1992 | 13 |
| 6-2 | 50 | 49 | 1 | 100 | Y, Ca | Mn, Cr | Cu | 0.521 | 0.024 | 2006 | 13 |
| 6-3 | 50 | 47 | 3 | 100 | Y, Ca | Mn, Cr | Cu | 0.361 | 0.021 | 1853 | 19 |
| 6-4 | 50 | 45 | 5 | 100 | Y, Ca | Mn, Cr | Cu | 0.213 | 0.015 | 1729 | 26 |
| 6-5 | 50 | 40 | 10 | 100 | Y, Ca | Mn, Cr | Cu | 0.081 | 0.007 | 1596 | 28 |
| 6-6 | 50 | 20 | 30 | 100 | Y, Ca | Mn, Cr | Cu | 0.136 | 0.009 | 1769 | 32 |
| 6-7 | 50 | 0 | 50 | 100 | Y, Ca | Mn, Cr | Cu | 0.312 | 0.016 | 1936 | 48 |
| 6-8 | 50 | 49 | 1 | 100 | Y, Ca | Mn, Cr | Sn | 0.615 | 0.029 | 1990 | 9 |
| 6-9 | 50 | 47 | 3 | 100 | Y, Ca | Mn, Cr | Sn | 0.601 | 0.027 | 2022 | 5 |
| 6-10 | 50 | 45 | 5 | 100 | Y, Ca | Mn, Cr | Sn | 0.511 | 0.026 | 1941 | 6 |
| 6-11 | 50 | 40 | 10 | 100 | Y, Ca | Mn, Cr | Sn | 0.623 | 0.029 | 1999 | 9 |
| 6-12 | 50 | 20 | 30 | 100 | Y, Ca | Mn, Cr | Sn | 0.936 | 0.036 | 2123 | 15 |
| 6-13 | 50 | 0 | 50 | 100 | Y, Ca | Mn, Cr | Sn | 11.623 | 0.062 | 3410 | 22 |
| 6-14 | 50 | 49 | 1 | 100 | Y, Ca | Mn, Cr | Sb | 0.721 | 0.028 | 2117 | 4 |
| 6-15 | 50 | 47 | 3 | 100 | Y, Ca | Mn, Cr | Sb | 0.925 | 0.034 | 2153 | 3 |
| 6-16 | 50 | 45 | 5 | 100 | Y, Ca | Mn, Cr | Sb | 1.521 | 0.054 | 2175 | 4 |
| 6-17 | 50 | 40 | 10 | 100 | Y, Ca | Mn, Cr | Sb | 3.516 | 0.122 | 2190 | 8 |
| 6-18 | 50 | 20 | 30 | 100 | Y, Ca | Mn, Cr | Sb | 8.125 | 0.295 | 2161 | 11 |
| 6-19 | 50 | 0 | 50 | 100 | Y, Ca | Mn, Cr | Sb | 16.250 | 0.562 | 2192 | 13 |
| 6-20 | 50 | 49 | 1 | 100 | Y, Ca | Mn, Cr | Bi | 0.866 | 0.031 | 2170 | 5 |
| 6-21 | 50 | 47 | 3 | 100 | Y, Ca | Mn, Cr | Bi | 1.032 | 0.039 | 2135 | 2 |
| 6-22 | 50 | 45 | 5 | 100 | Y, Ca | Mn, Cr | Bi | 1.886 | 0.071 | 2137 | 6 |
| 6-23 | 50 | 40 | 10 | 100 | Y, Ca | Mn, Cr | Bi | 4.416 | 0.168 | 2130 | 11 |
| 6-24 | 50 | 20 | 30 | 100 | Y, Ca | Mn, Cr | Bi | 8.125 | 0.312 | 2124 | 13 |
| 6-25 | 50 | 0 | 50 | 100 | Y, Ca | Mn, Cr | Bi | 16.130 | 0.632 | 2111 | 16 |

Table 3 shows the resistance values, B constants and resistance changes of samples obtained by adding Cu, Sn, Sb and Bi to the composition of Sample No. 6 having a comparatively low B constant relative to a resistance value at −40° C. and good resistance change.

When Cu or Sn is added in an amount up to 30 wt %, the resistance value and B constant are decreased, and when it is added in an amount of 50 wt %, the resistance value is increased.

However, in the case of Sb or Bi, there is almost no increase in the B constant relative to an increase in the resistance value. In most thermistors, as the resistance value is increased, the B constant is also increased. But, in the case of Sb or Bi, it attracts free electrons excited by heat due to substitution with the element of the B site or may hinder the flow of electrons due to intergranular effects, and thus an increase in the B constant appears to be suppressed.

Also, when Sb or Bi is allowed to stand at high temperature in some cases, resistance changes are also decreased.

TABLE 4

| Sample | M1 | M2 | M3 | | M1 | M2 | M3 | R100 | R600 | B(100/ | Resistance |
|---|---|---|---|---|---|---|---|---|---|---|---|
| No. | Element | Element | Element | Total | Element | Element | Element | (kΩ) | (kΩ) | 600) | Change (%) |
| 10-1 | 50 | 50 | 0 | 100 | Y, Ca | Mn, Fe | — | 0.649 | 0.018 | 2336 | 13 |
| 10-2 | 50 | 49 | 1 | 100 | Y, Ca | Mn, Fe | Cu | 0.556 | 0.0143 | 2385 | 19 |
| 10-3 | 50 | 47 | 3 | 100 | Y, Ca | Mn, Fe | Cu | 0.361 | 0.0151 | 2068 | 23 |
| 10-4 | 50 | 45 | 5 | 100 | Y, Ca | Mn, Fe | Cu | 0.267 | 0.012 | 2022 | 25 |
| 10-5 | 50 | 40 | 10 | 100 | Y, Ca | Mn, Fe | Cu | 0.133 | 0.008 | 1832 | 32 |
| 10-6 | 50 | 20 | 30 | 100 | Y, Ca | Mn, Fe | Cu | 0.061 | 0.007 | 1411 | 48 |
| 10-7 | 50 | 0 | 50 | 100 | Y, Ca | Mn, Fe | Cu | 0.694 | 0.011 | 2701 | 51 |
| 10-8 | 50 | 49 | 1 | 100 | Y, Ca | Mn, Fe | Sn | 1.116 | 0.014 | 2853 | 13 |
| 10-9 | 50 | 47 | 3 | 100 | Y, Ca | Mn, Fe | Sn | 0.981 | 0.013 | 2817 | 8 |
| 10-10 | 50 | 45 | 5 | 100 | Y, Ca | Mn, Fe | Sn | 1.216 | 0.015 | 2864 | 6 |
| 10-11 | 50 | 40 | 10 | 100 | Y, Ca | Mn, Fe | Sn | 2.163 | 0.018 | 3121 | 15 |
| 10-12 | 50 | 20 | 30 | 100 | Y, Ca | Mn, Fe | Sn | 4.362 | 0.023 | 3418 | 16 |
| 10-13 | 50 | 0 | 50 | 100 | Y, Ca | Mn, Fe | Sn | 8.216 | 0.031 | 3636 | 15 |
| 10-14 | 50 | 49 | 1 | 100 | Y, Ca | Mn, Fe | Sb | 1.119 | 0.093 | 1621 | 11 |
| 10-15 | 50 | 47 | 3 | 100 | Y, Ca | Mn, Fe | Sb | 1.468 | 0.103 | 1731 | 3 |
| 10-16 | 50 | 45 | 5 | 100 | Y, Ca | Mn, Fe | Sb | 1.883 | 0.117 | 1811 | 6 |
| 10-17 | 50 | 40 | 10 | 100 | Y, Ca | Mn, Fe | Sb | 3.516 | 0.244 | 1738 | 13 |
| 10-18 | 50 | 20 | 30 | 100 | Y, Ca | Mn, Fe | Sb | 5.136 | 0.311 | 1827 | 15 |
| 10-19 | 50 | 0 | 50 | 100 | Y, Ca | Mn, Fe | Sb | 9.336 | 0.615 | 1772 | 16 |
| 10-20 | 50 | 49 | 1 | 100 | Y, Ca | Mn, Fe | Bi | 1.468 | 0.086 | 1849 | 5 |
| 10-21 | 50 | 47 | 3 | 100 | Y, Ca | Mn, Fe | Bi | 1.922 | 0.094 | 1967 | 3 |
| 10-22 | 50 | 45 | 5 | 100 | Y, Ca | Mn, Fe | Bi | 2.335 | 0.133 | 1867 | 9 |
| 10-23 | 50 | 40 | 10 | 100 | Y, Ca | Mn, Fe | Bi | 4.446 | 0.211 | 1986 | 17 |
| 10-24 | 50 | 20 | 30 | 100 | Y, Ca | Mn, Fe | Bi | 7.361 | 0.308 | 2068 | 15 |
| 10-25 | 50 | 0 | 50 | 100 | Y, Ca | Mn, Fe | Bi | 10.632 | 0.416 | 2112 | 16 |

Table 4 shows the resistance values, B constants and resistance changes of samples obtained by adding Cu, Sb and Bi oxides in different amounts to the composition of Sample No. 10 having Fe instead of Cr at the M2 position.

When using the other elements except for Sn, the overall resistance value is low and the B constant is also low, and a high-temperature resistance change becomes stable except for Cu. In particular, Bi exhibits very good resistance stability when being used in an amount of 5% or less.

Furthermore, in Sample No. 10-19, when the M2 position is completely occupied with Sb, a high resistance value at 600° C. is maintained relative to a high resistance value at 100° C., to and also a low B constant is obtained, but the resistance change is as high as 16%.

TABLE 5

| Sample | M1 | M2 | M3 | | M1 | M2 | M3 | R100 | R600 | B(100/ | Resistance |
|---|---|---|---|---|---|---|---|---|---|---|---|
| No. | Element | Element | Element | Total | Element | Element | Element | (kΩ) | (kΩ) | 600) | Change (%) |
| 18-1 | 50 | 50 | 0 | 100 | Y, Ca | Mn, Al | — | 1.009 | 0.029 | 2313 | 4 |
| 18-2 | 50 | 49 | 1 | 100 | Y, Ca | Mn, Al | Cu | 0.954 | 0.028 | 2299 | 8 |
| 18-3 | 50 | 47 | 3 | 100 | Y, Ca | Mn, Al | Cu | 0.722 | 0.026 | 2166 | 12 |
| 18-4 | 50 | 45 | 5 | 100 | Y, Ca | Mn, Al | Cu | 0.411 | 0.0201 | 1967 | 13 |
| 18-5 | 50 | 40 | 10 | 100 | Y, Ca | Mn, Al | Cu | 0.216 | 0.016 | 1696 | 15 |
| 18-6 | 50 | 20 | 30 | 100 | Y, Ca | Mn, Al | Cu | 0.135 | 0.014 | 1477 | 18 |
| 18-7 | 50 | 0 | 50 | 100 | Y, Ca | Mn, Al | Cu | 0.065 | 0.008 | 1363 | 16 |
| 18-8 | 50 | 49 | 1 | 100 | Y, Ca | Mn, Al | Sn | 0.991 | 0.029 | 2301 | 4 |
| 18-9 | 50 | 47 | 3 | 100 | Y, Ca | Mn, Al | Sn | 0.846 | 0.028 | 2221 | 3 |
| 18-10 | 50 | 45 | 5 | 100 | Y, Ca | Mn, Al | Sn | 0.664 | 0.026 | 2111 | 3 |
| 18-11 | 50 | 40 | 10 | 100 | Y, Ca | Mn, Al | Sn | 0.411 | 0.021 | 1938 | 3 |
| 18-12 | 50 | 20 | 30 | 100 | Y, Ca | Mn, Al | Sn | 0.316 | 0.023 | 1707 | 3 |
| 18-13 | 50 | 0 | 50 | 100 | Y, Ca | Mn, Al | Sn | 0.169 | 0.016 | 1536 | 3 |
| 18-14 | 50 | 49 | 1 | 100 | Y, Ca | Mn, Al | Sb | 1.113 | 0.029 | 2377 | 2 |
| 18-15 | 50 | 47 | 3 | 100 | Y, Ca | Mn, Al | Sb | 1.521 | 0.039 | 2387 | 2 |
| 18-16 | 50 | 45 | 5 | 100 | Y, Ca | Mn, Al | Sb | 2.684 | 0.066 | 2415 | 2 |
| 18-17 | 50 | 40 | 10 | 100 | Y, Ca | Mn, Al | Sb | 4.221 | 0.091 | 2500 | 2 |
| 18-18 | 50 | 20 | 30 | 100 | Y, Ca | Mn, Al | Sb | 6.216 | 0.127 | 2535 | 2 |
| 18-19 | 50 | 0 | 50 | 100 | Y, Ca | Mn, Al | Sb | 9.163 | 0.226 | 2413 | 2 |
| 18-20 | 50 | 49 | 1 | 100 | Y, Ca | Mn, Al | Bi | 1.335 | 0.041 | 2270 | 2 |
| 18-21 | 50 | 47 | 3 | 100 | Y, Ca | Mn, Al | Bi | 1.881 | 0.094 | 1952 | 2 |
| 18-22 | 50 | 45 | 5 | 100 | Y, Ca | Mn, Al | Bi | 3.551 | 0.164 | 2004 | 1 |
| 18-23 | 50 | 40 | 10 | 100 | Y, Ca | Mn, Al | Bi | 5.556 | 0.213 | 2125 | 2 |
| 18-24 | 50 | 20 | 30 | 100 | Y, Ca | Mn, Al | Bi | 7.168 | 0.224 | 2258 | 2 |
| 18-25 | 50 | 0 | 50 | 100 | Y, Ca | Mn, Al | Bi | 10.361 | 0.316 | 2274 | 2 |

Table 5 shows the resistance values, B constants and high-temperature resistance changes of samples obtained by adding Cu, Sn, Sb and Bi oxides in different amounts to the composition of Sample No. 18 having Al instead of Cr at the M2 position.

The addition of Al is intended to increase the overall resistance value but the use of Cu, Sn, Sb or Bi oxide is intended to decrease the B constant.

In Sample Nos. 18-21˜23, high resistance values and low B constants are maintained, whereas high-temperature resistance changes are considerably stable. This is considered to be because high resistivity and a low B constant are maintained due to interaction of Al oxide and Bi.

As results of measurement of resistance values, B constants and high-temperature resistance changes of samples obtained by adding the base composition with Cu, Sn, Sb and Bi as shown above, when Sn of Group 4B or Sb or Bi of Group 5B is added, the resistance value is increased and the B constant is decreased, and the high-temperature resistance change becomes stable.

Also, in the case where the mixing ratio of A and B in ABO3 is 1:1, when M1 elements are provided at the A position; M2+M3 elements are provided at the B position; and the following relations are satisfied:

0≦M1≦1

0≦M2+M3≦1

0≦M3≦0.6,

the resistance value is increased and the B constant is comparatively suppressed, and the change is decreased.

1. A ceramic composition for a thermistor temperature sensor, prepared by adding a perovskite phase having a perovskite crystalline structure represented by ABO3 with Sn of Group 4B or Sb or Bi of Group 5B,
wherein A comprises at least one element selected from among Groups 2A and 3A elements except for LA, and
B comprises at least one element selected from among transition metals of Groups 4A, 5A, 6A, 7A, 8A, 2B and 3B.

2. The ceramic composition of claim 1, wherein a mixing ratio of A and B in the perovskite crystalline structure represented by ABO3 is 1:1, and
when the element of A is set to M1; the element of B is set to M2; and Sn of Group 4B or Sb or Bi of Group 5B is set to M3,
M1, M2 and M3 satisfy one or more selected from among the following relations:
0≦M1≦1
0≦M2+M3≦1
0≦M3≦0.6.

3. The ceramic composition of claim 2, wherein M1 comprises one or more selected from the group consisting of Y₂O₃, CaCO₃, SrO₂ and MgO.

4. The ceramic composition of claim 2, wherein M2 comprises one or more selected from the group consisting of MnO₂, Cr₂O₃ and NiO.

5. The ceramic composition of claim 2, wherein M3 comprises one or more selected from the group consisting of CuO, SnO, Sb₂O₃, Bi₂O₃, Al₂O₃ and Fe₂O₃.

6. A thermistor device manufactured using the ceramic composition of claim 1.

7. A temperature sensor, manufactured using the thermistor device of claim 6.

8. The ceramic composition of claim 1, wherein the ceramic composition has a temperature gradient constant of 1800˜2600K in a temperature range of −40˜1000° C.

9. The ceramic composition of claim 2, wherein the ceramic composition has a temperature gradient constant of 1800˜2600K in a temperature range of −40˜1000° C.
